(19) United States
(12) Patent Application Publication
(10) Pub. No.: US 2010/0170406 A1
(43) Pub. Date: Jul. 8, 2010

(54) JUG FUNCTIONING TO SQUEEZE JUICE

(76) Inventor: HSIAO CHENG CHUANG, Lu Chu Hsiang (TW)

Correspondence Address: HDLS IPR Services, PO Box 220746, Chantilly, VA, 20153, US

(21) Appl. No.: 12/349,508

(22) Filed: Jan. 6, 2009

(51) Int. Cl. A47J 19/02

(52) U.S. Cl. 100/126; 100/131

(57) ABSTRACT

A jug functioning to squeeze juice includes a top cover. The top cover is provided for shielding, the bottom side of which is formed with a juice squeeze pedestal. Thus, when the top cover is right set on the jug body, a jug cover is formed. When the top cover is upside down and assembled onto the jug body, the juice squeeze pedestal may be used to squeeze juice. The innovative jug may fill drinking water and further functions to squeeze juice.

### BACKGROUND OF THE INVENTION

1. Field of the Invention

This invention relates to a jug functioning to squeeze juice.

2. Description of the Related Art

Generally, in order to easily fill drinking water, a jug is purchased for daily life at home. A conventional jug comprises a jug body and a jug cover, in which the jug body may be used to fill drinking water and the jug cover may be used to shield the top of jug for hygiene. The conventional jug simply functions to fill water and has not been changed for innovation for a long time.

The modern people pay more attention to health, and many medical study reports tell the nutrition of fruit that is of great benefit to human health. In order to squeeze juice, many people must purchase a dynamoelectric juice extractor, which costs the people more and runs in opposite directions of energy saving. Furthermore, the space where the modern people live is smaller and smaller, and the goods are more and more, so it is necessary to design a portable commodity provided with multiple functions that works without power and saves space.

In order to solve the defects, the multi-functional jug according to this invention is provided that may fill drinking water and squeeze juice.

Consequently, because of the technical defects of described above, the applicant keeps on carving unflaggingly through wholehearted experience and research to develop the present invention, which can effectively improve the defects described above.

### SUMMARY OF THE INVENTION

A multi-functional jug functioning to squeeze juice according to this invention is provided, and a juice squeeze pedestal is provided in the top cover or concretely in the basal plane of the top cover. When being set right on the jug body, the top cover is a jug cover of shielding; contrarily, when the top cover is set upside down and fits together with the jug body, the juice squeeze pedestal may squeeze juice.

Further, in this invention, a collection pan is provided between the jug body and the top cover to serve as a salad bowl and collect the juice squeezed from a fruit.

### BRIEF DESCRIPTION OF THE DRAWINGS

FIG. 1 is a perspective exploded view of this invention;

FIG. 2 is a perspective assembly drawing of the appearance of this invention;

FIG. 3 is another perspective assembly drawing of the appearance of this invention;

FIG. 4 is a schematic view illustrating a service state of juice squeeze of this invention;

FIG. 5 is a cross sectional view of FIG. 4; and

FIG. 6 is a schematic view illustrating a juice squeeze pedestal according to this invention that may be set on a juice squeeze base.

### DETAILED DESCRIPTION OF THE PREFERRED EMBODIMENTS

Now, the present invention will be described more specifically with reference to the following embodiments. It is to be noted that the following descriptions of preferred embodiments of this invention are presented herein for purpose of illustration and description only; it is not intended to be exhaustive or to be limited to the precise form disclosed.

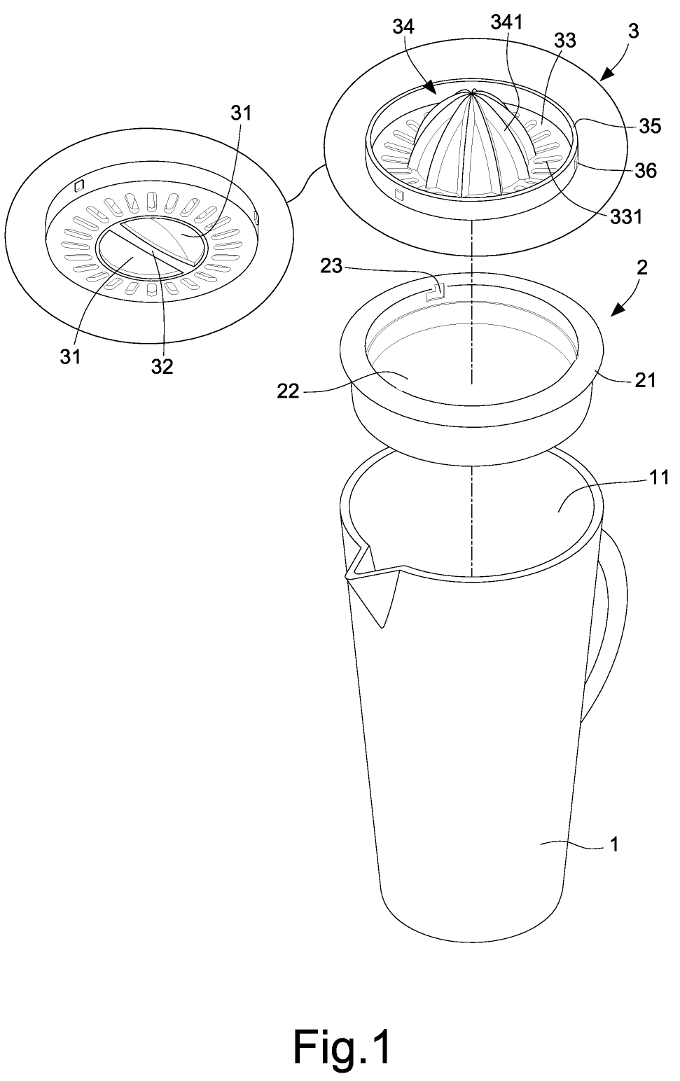

With reference to FIGS. 1 through 3, a jug functioning to squeeze juice according to this invention comprises a jug body 1, a collection pan 2, and a top cover 3.

The jug body 1 is a conventional framework inside which a capacity chamber 11 is formed for drinking water or juice.

A convex ring 21 is formed around the fringe of collection pan 2 to be set across the upper fringe of jug body 1. A depressed collection space 22 is formed inside the collection pan 2. Further, random amounts of wedge slots 23 are formed around the fringe of collection space 22.

A top side of the top cover 3 is formed with two concave portions 31 between which a hold slab 32 is formed; an opposite bottom side is formed with an annular slab 33. A nick 331 is formed on the slab 33. An outwards convex juice squeeze pedestal 34 is formed in the center of slab 33. Several ribs 341 are radially formed on the juice squeeze pedestal 34. A ring 35 is formed around the fringe of slab 33. A wedge lug 36 is properly around the exterior of ring 35. The wedge lug 36 may wedge to the wedge slot 23.

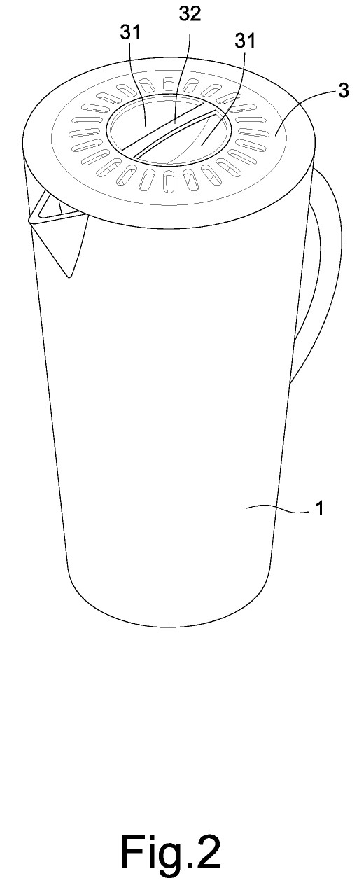

With the members, when the top cover 3 is right set, namely the juice squeeze pedestal 34 be upside down, the top cover 3 may be set on the collection pan 2. Next, the collection pan 2 may be set on the jug body 1 for implementation of the service state of just as shown in FIG. 2. Here, the two concave portions 31 of the top cover 3 work with the hold slab 32, and thus a user may take the top cover 3 with index finger and thumb.

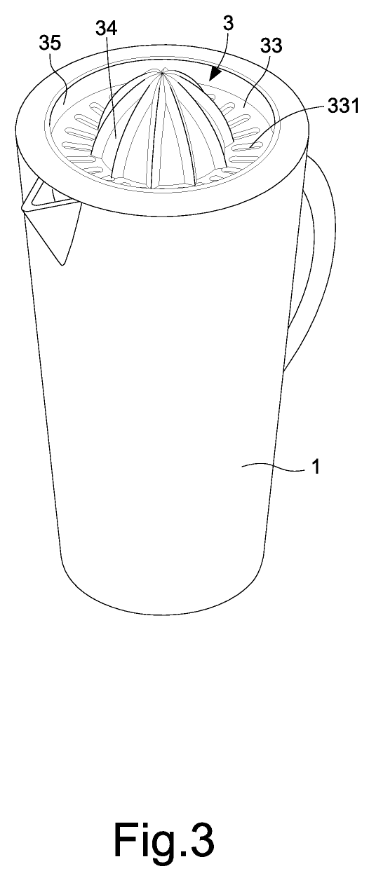

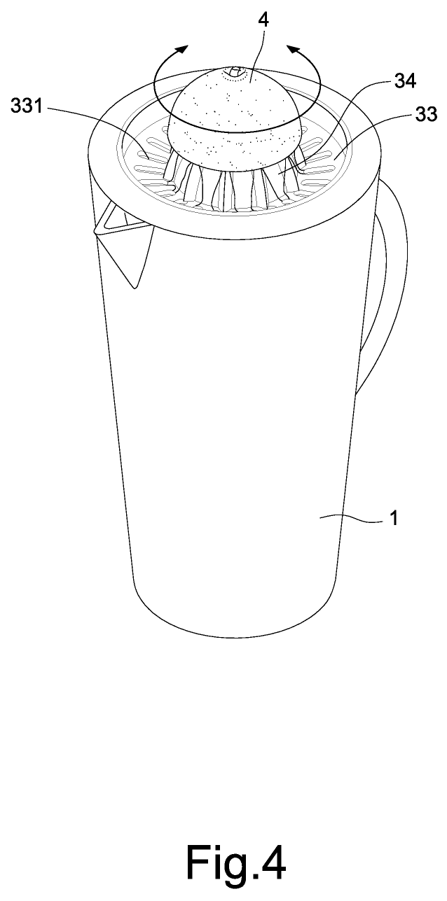

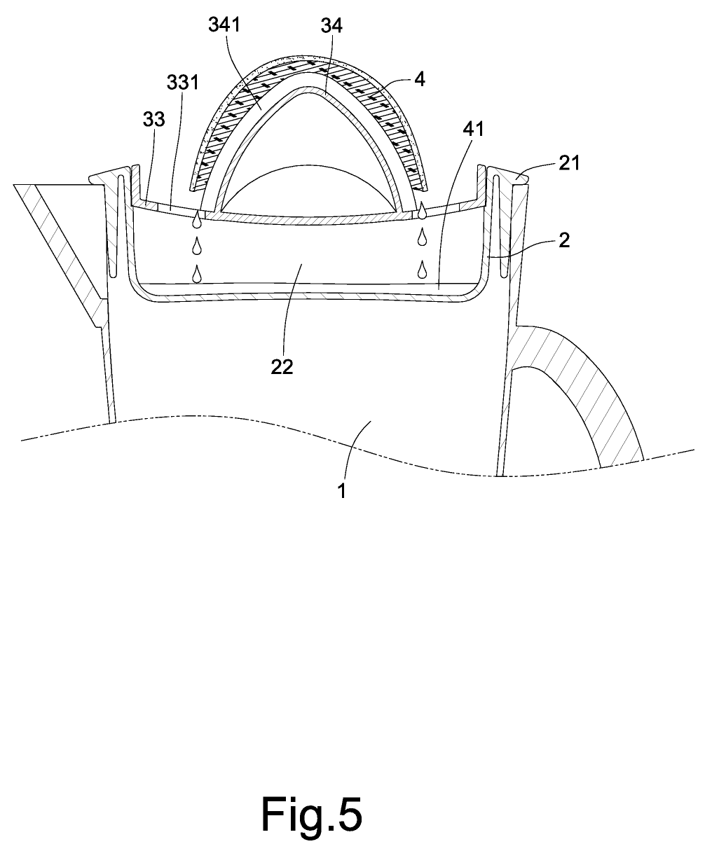

When the top cover 3 is upside down, as shown in FIG. 3, naming the juice squeeze pedestal 34 being set upwards, and when the top cover 3 is set on the collection pan 2 that is set on the jug body 1, the juice squeeze pedestal 34 may function to squeeze juice. As shown in FIG. 4, a half cut fruit 4, such as an orange or lemon, the pulp of which is pressed and rotated on the juice squeeze pedestal 34, and the juice squeeze pedestal 34 and the ribs 341 may be used to squeeze juice from the fruit pulp, as shown in FIG. 5, and the juice 41 flows through the nick 331 along the juice squeeze pedestal 34 and finally falls in the collection space 22 of collection pan 2.

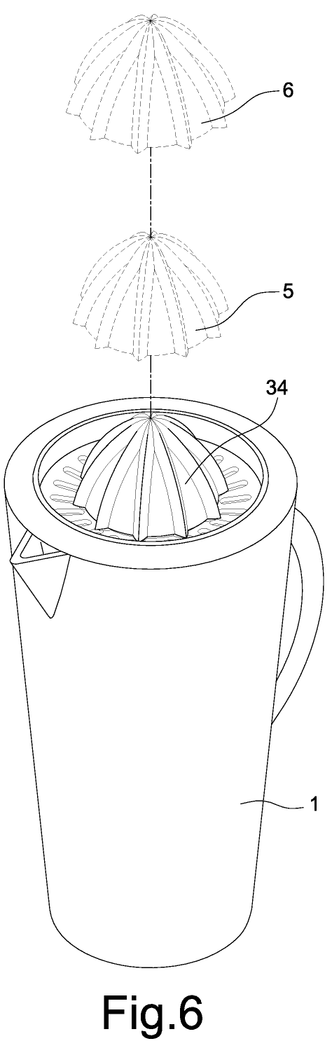

With reference to FIG. 6, owing to the requests of the volumes of different fruits for juice squeeze, such as a grapefruit larger than the orange, juice squeeze bases 5 and 6 each of the volumes of which is increased may be additionally provided outside on the juice squeeze pedestal 34 according to this invention.

In this invention of clever thought, especially when the single top cover 3 is right set, a jug cover is formed and the juice squeeze pedestal 34 is hidden below, and when the top cover 3 is upside down, juice squeeze may be achieved.

To sum up, the jug functioning to squeeze juice according to this invention also functions to squeeze juice manually. Purchasing the single product, the consumer may enjoy double functions. Thus, the space and cost may be saved, and the hand-operation juice squeeze device works without power indoors and outdoors, which keeps the user taking exercise.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A jug functioning to squeeze juice, comprising:
a jug body inside which a capacity chamber is formed; and
a top cover being provided on the top of jug body, in which a juice squeeze pedestal is provided on one side of the top cover.

2. The jug functioning to squeeze juice according to claim 1, wherein the top cover is formed with an annular slab near the juice squeeze pedestal and a nick is formed on the slab.

3. The jug functioning to squeeze juice according to claim 1, wherein several ribs are radially formed on the juice squeeze pedestal.

4. The jug functioning to squeeze juice according to claim 1, wherein the other side of the top cover of juice squeeze pedestal is formed with a hold slab.

5. The jug functioning to squeeze juice according to claim 4, wherein concave portions are formed at two sides of the hold slab.

6. The jug functioning to squeeze juice according to claim 2, wherein a ring is formed around the fringe of slab.

7. The jug functioning to squeeze juice according to claim 6, wherein a wedge lug is properly around the exterior of ring.

8. The jug functioning to squeeze juice according to claim 1, wherein a collection pan is provided between the jug body and the top cover, a convex ring is formed around the fringe of collection pan to be set across the upper fringe of jug body, and a depressed collection space is formed inside the collection pan.

9. The jug functioning to squeeze juice according to claim 8, wherein wedge slots are formed around the fringe of collection space.

10. The jug functioning to squeeze juice according to claim 2, wherein the ring is formed around the fringe of slab, the wedge lug is properly around the exterior of ring, the collection pan is provided between the jug body and the top cover, the interior of collection pan is formed with wedge slots into which the lugs wedge.
